(19) United States
(12) Patent Application Publication
(10) Pub. No.: US 2024/0163639 A1
(43) Pub. Date: May 16, 2024

(54) LOCATION NOTIFICATION SYSTEM AND METHOD

(71) Applicant: Faramarz KHALILI, Great Neck, NY (US)

(72) Inventor: Faramarz KHALILI, Great Neck, NY (US)

(21) Appl. No.: 17/986,128

(22) Filed: Nov. 14, 2022

(51) Int. Cl. H04W 4/029; H04W 4/02

(52) U.S. Cl. CPC H04W 4/029; H04W 4/023

(57) ABSTRACT

There is disclosed a system for tracking whether people are present in a predetermined region, this system can include at least one tracking board, and at least one transponder which is being tracked. The tracking board can include an identity indicator to indicate the identity of the person being tracked and a presence indicator to indicate whether the person being tracked is present in the region. The tracking board can comprise a mirror, a microprocessor. The presence indicator can comprise a LED light. These lights can include red light to signify that the person being tracked is outside of the predetermined region and at least one green light to indicate that the person being tracked is within the region. In at least one embodiment the region is a geolocation which can be defined by GPS coordinates, a WIFI connection or by connection to a nearfield transponder.

### BACKGROUND OF THE INVENTION

One embodiment relates to a notification system and method for tracking people/users. In the past, when parents would go to bed and their children were out, the parents may fall asleep and not hear their children come home. The parents would then have to get out of bed to check to see if their children came home in the night. Therefore, there is a need for a system and method for tracking users such as children and letting other users such as parents know when the children come home in the evening. There is also another need for employers to track their employees to see when these employees arrive at their work site and leave their work site.

### SUMMARY

There is disclosed a system for tracking whether people are present in a predetermined region, this system can include at least one tracking board, and at least one transponder which is being tracked. The tracking board can include an identity indicator to indicate the identity of the person being tracked and a presence indicator to indicate whether the person being tracked is present in the region. The tracking board can comprise a mirror, a microprocessor. The presence indicator can comprise a LED light. These lights can include red light to signify that the person being tracked is outside of the predetermined region and at least one green light to indicate that the person being tracked is within the region. In at least one embodiment the region is a geolocation which can be defined by GPS coordinates, a WIFI connection or by connection to a nearfield transponder.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views;

FIG. 1 is a plan view of a board which is configured to notify a first user of the presence of a second user in a particular area;

FIG. 2 is a second embodiment which notifies a first user of the presence of a second user in an area;

FIG. 3 is a view of a check in board which is in communication with any one of the boards of FIGS. 1 and 2;

FIG. 4 is a schematic layout of a network of components in the system;

FIG. 5A is a block diagram of the server components;

FIG. 5B is a block diagram of the notification systems of FIGS. 1 and 2;

FIG. 50 is a diagram of the transponder;

FIG. 6 is a view of a portable phone for use with the system;

FIG. 7 is a view of a business board;

FIG. 8A is another view of another business board;

FIG. 8B is a view of boards in tandem with each other;

FIG. 9 is a view of a screen for monitoring employees;

FIG. 10 is a flow chart of the process for use with the system;

FIG. 11 is a flow chart for the process for use with business systems;

FIG. 12 is a flow chart for use with a portable device; and

FIG. 13 is a block diagram of a screen of the electronic device.

### DETAILED DESCRIPTION

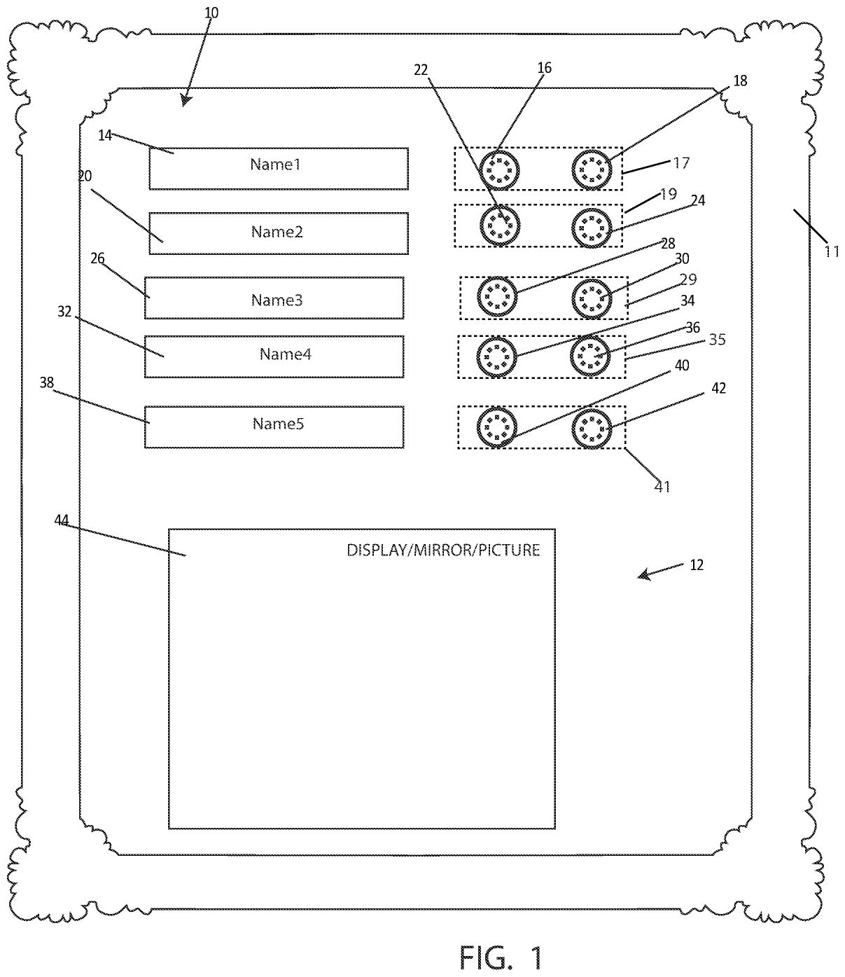

FIG. 1 is a plan view of a board 10 which is configured to notify a first user of the presence of a second user in a particular area. This board 10 is configured to be disposed inside of a frame 11 such as a picture frame or any other suitable frame. The board portion 12 includes a plurality of different presence indicators such as lights 16, 18, 22, 24, 28, 30, 34, 36, 40, and 42. Lights 16, 22, 28, 34, and 40 are for example green lights, such as LED lights which indicate the presence of the associated user in a particular region. Lights 18, 24, 30, 36, and 40 are for example red lights, such as LED lights which indicate that the user is not within a particular predetermined region. This board also includes a plurality of different identity indicators such as nameplates including nameplates 14, 20, 26, 32, and 38. There is also a display and or mirror 44 positioned adjacent to these nameplates and or lights. The board portion 12 can be any suitable type of board made from metal wood plastic or composite. The lights can be any suitable type of light but can be for example LED lights. The nameplates 14, 20, 26, 32, and 38 can be any suitable nameplates but in at least one example are engraved metal plates. In another example, these plates are in the form of a whiteboard that can be written on, it can be a corkboard for placement of names, alternatively it can include a plastic cover which allows a paper sheet to be slid therein, or for example these nameplates 14, 20, 26, 32, and 38 can be LED screens indicating the names of the parties associated with the adjacent Tights. For example, nameplate 14 can be associated with lights 16 and 18 located in region 17. Nameplate 20 can be associated with lights 22 and 24 located in region 19. Nameplate 26 can be associated with lights 28 and 30 located in region 29. Nameplate 32 can be associated with lights 34 and 36 located in region 35. Nameplate 38 can be associated with lights 40 and 42 located in region or board section 41. When a user is present in a predetermined geographical region the associated green light is lit. When the user is not present in the geographical location, then the associated red light is lit.

This board can be hung on a wall such as like a picture frame or such as via a flatscreen. While the above embodiment mentions green or red lights, any color lights or indicators can be used to signify the presence or absence of a person listed in the name plates or identified.

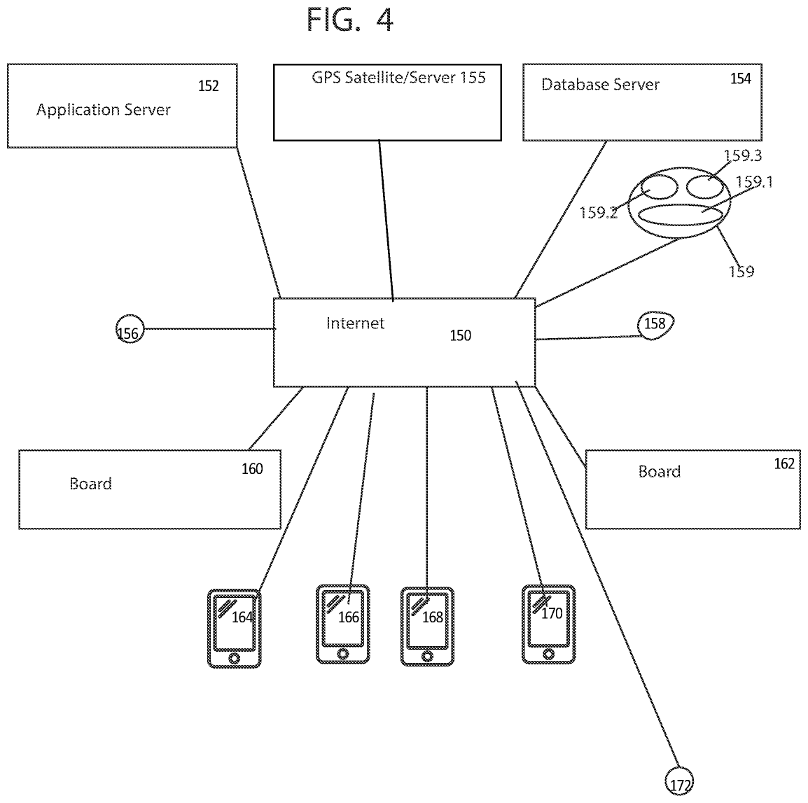

Display 44 and or mirror can be in the form of a simple flat mirror or in the form of a flat screen display such as an LED display or in the form of a picture. If the display is an LED display or video screen, the LED display 44 is configured to provide a display of the location of the users which are being tracked. Therefore, for each user that is not within the predefined geolocation the display 44 will display location of the user on a map. The tracking of the user would be such that the phone used by the user would be tracked for GPS location and the location of the user would be forwarded to a server such as server 152 shown in FIG. 4. This information would then be forwarded to an associated board 160 or board 162 (See FIG. 4) or in this case board

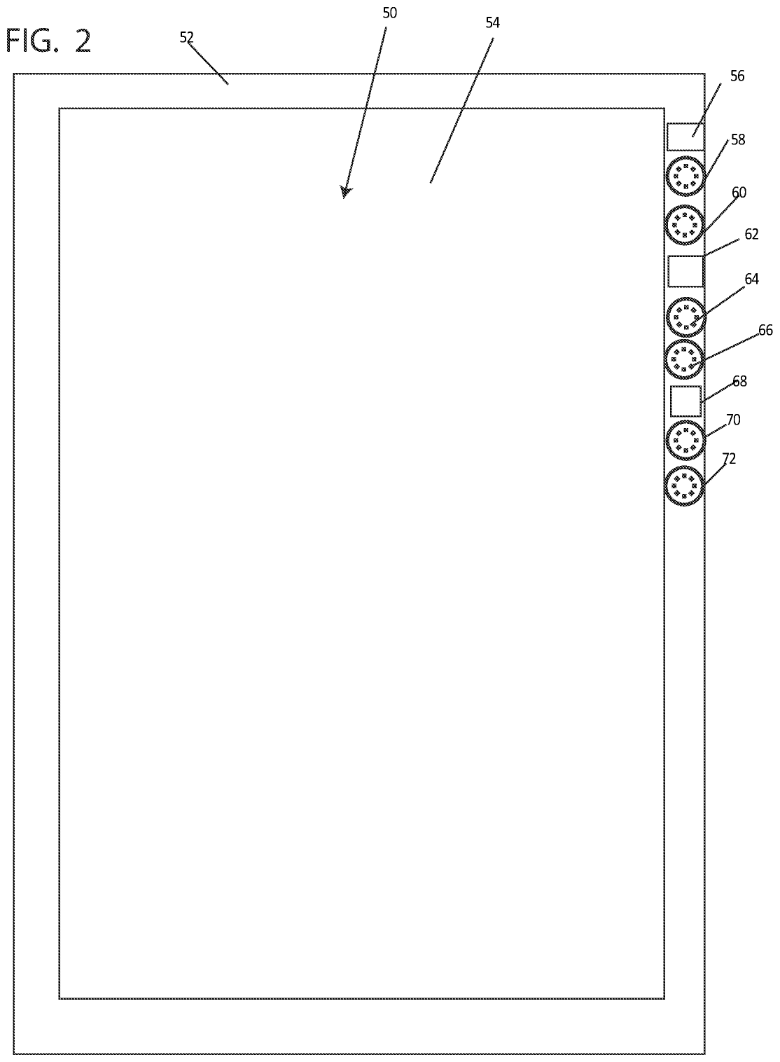

FIG. 2 is a view of another embodiment which is a board 50. This embodiment of board 50 includes a board section 54 and a frame 52. Board section 54 can be in the form of a picture and or a mirror. Embedded in frame 52 are a plurality of identifiers 56, 62, and 68. Each of these identifiers are configured to identify a particular user to be tracked. These identifiers 56, 62, and 68 are similar to the nameplates 14, 20, 26, 32 and 38 of FIG. 1. For example, these identifiers 56, 62, and 68 can be in the form of a whiteboard, a corkboard, a plastic cover for receiving inserts an LED display, or any other suitable display to display the identity the of the user.

Lights 58, 64, and 70 are green lights indicating that the associated user and identifiers 56, 62, and 68 respectively are within the predefined geolocation such as within a home. Lights 60, 66, and 72 are red lights, indicating that the associated user s not within the predefined geolocation such as outside a home. Thus, when a user leaves a home, the indicator such as light 60 would turn red indicating that the user is outside of this predetermined geolocation such as home. When the user returns home, red light 60 turns off and green light 58 turns on indicating that the user is now home.

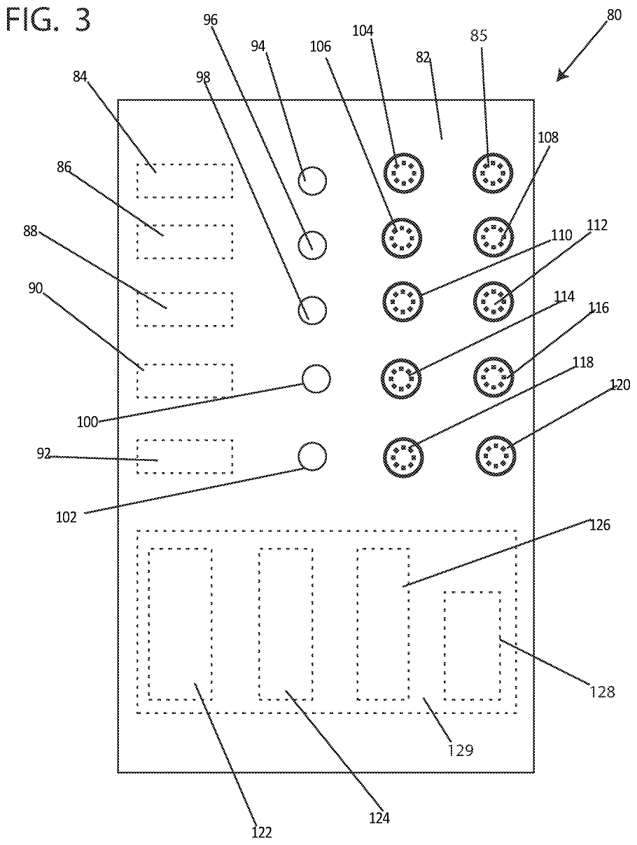

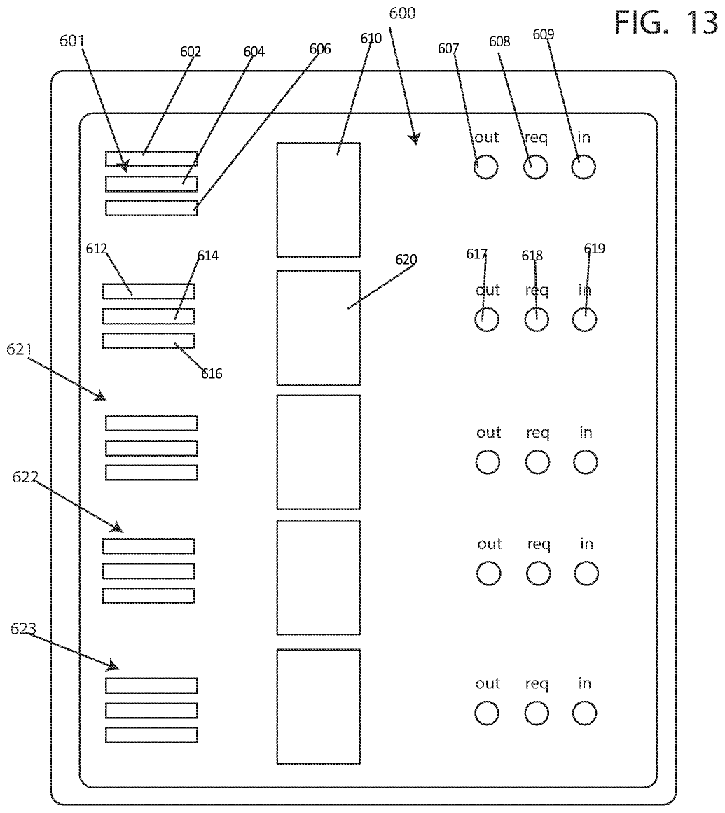

FIG. 3 is a view of a check-in board which is in communication with any one of the boards of FIGS. 1 and 2. This board 80 includes a base section or motherboard 82 a plurality of indicators 104, 106, 110, 114 and 118 which are green LEDs while LEDs 85, 108, 112, 116, and 120 are red LEDs. There are also a plurality of hooks 94, 96, 98, 100, and 102. There also a plurality of near field detectors 84, 86, 88, 90, and 92. The near field indicators are set to go off when a person puts their keys having an associated tracker on the associated hook. For example, when a person puts their keys on hook 94, an associated tracker 84 detects the presence of the keys having its associated tracker (See tracker 258 in FIG. 50). The placement of the keys on hook 94 would then result in green LED 104 lighting up and red LED 85 turning off. Alternatively, once of the user places their keys on hook 96 those keys would be adjacent to tracker 88. Keys having its own tracker coupled to the keys would then trigger tracker 88 to send a signal to microprocessor 122 to cause red LED 108 to turn off and green LED 106 to turn on. Alternatively, when a user places their keys on hook 96 those keys having an associated tracker would trigger near field tracker 88 causing red LED 112 to turn off and green LED to turn on this occurs by near field tracker 88 signaling to microprocessor 122 to turn LED 112 off and LED 110 on.

In addition, when a user places their keys on hook 100 those keys having its own tracker would interact with near field tracker 90 near field tracker 90 would send a signal to microprocessor 122 causing a red LED 116 to turn off and green LED 114 to turn on.

Furthermore, if the user hangs their keys on hook 102 those keys if they have a tracker would be positioned adjacent to near field tracker 92 which would then cause light 118 to light up while light 120 a red light would turn off. Again, while the terms red and green are used for the color of the lights, other colors can be used to indicate the presence or absence of a person.

To help determine the presence of a party, there is a microprocessor. Microprocessor 122 is fed by memory 124. Memory 124 is filled with programmatic instructions which are fed through the motherboard to microprocessor 122 wherein microprocessor 122 performs these instructions. In addition, there is also shown transponder 126 which is in communication with microprocessor 122. Transponder 126 is configured to communicate with associated servers such as application server 152 or database server 154 or GPS server 155 through the internet 150 (See FIG. 4). AD of these components are powered by power supply 128 on board 129.

FIG. 4 is a schematic block diagram of the computer network for the system. In this view, there is an application server 152 and a database server 154. Both application server 152 and database server 154 are configured to communicate through the Internet 150. In addition, there is also a GPS satellite/server 155 wherein this GPS satellite/server 155 is configured to either communicate directly with portable devices via WIFI or Cellular, or via GPS transponders. There can also be transponders 156, 158 and 172 in communication through the Internet to application servers 152 and database server 154. In addition, boards 160 and 162 are in communication with each other and with respective application server 152 and database server 154. Board 160 is representative of any one of boards 10 and 50, while board 162 is representative of board 80. In addition, any one of phones such as anyone of portable smart phones 164, 166, 168 or 170 having GPS can be in communication with the Internet 150. These phones can include phone 164, phone 166, phone 168, and phone 170. All of these electronic devices are in communication with each other through the Internet such as Internet 150. For example, each of these phones 164, 166, 168, 170 are in communication with both the boards 160 and 162 as well as application server 152 and database server 154. In addition, all of these components are in communication with GPS satellite server 155. There is also shown a lock such as lock 159, which includes at least a microprocessor 159.2, a transceiver 159.3 as well as other components on a motherboard 159.1. The components on the motherboard can include a battery, a memory, a storage for programs, a solenoid to drive the lock from a closed position to an open position and back again to a closed position. The lock can be remotely operated based upon the system reading that all desired people have arrived or reside in the pre-defined geographic location.

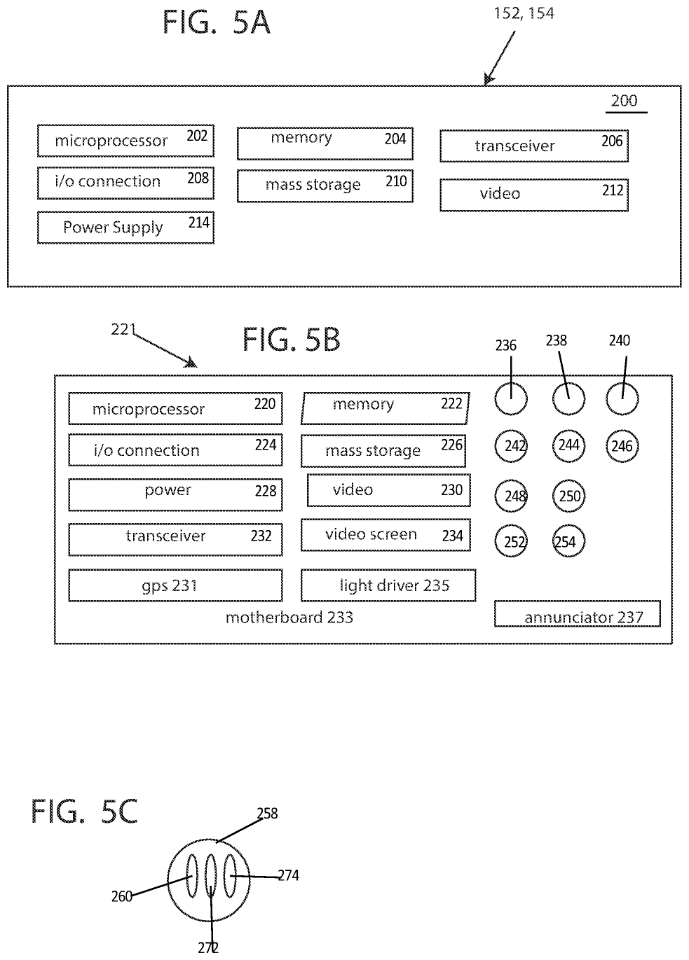

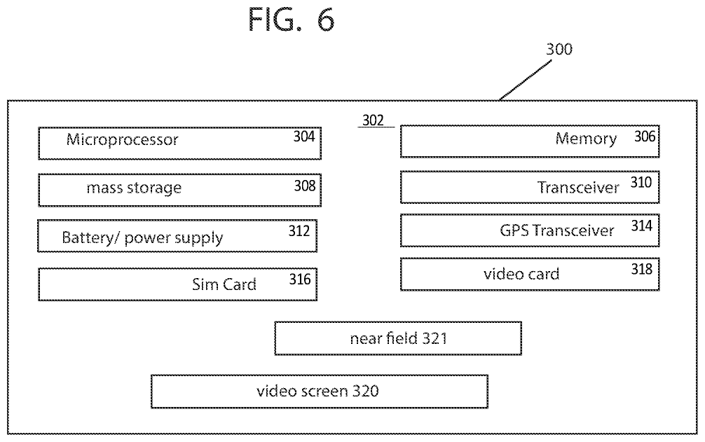

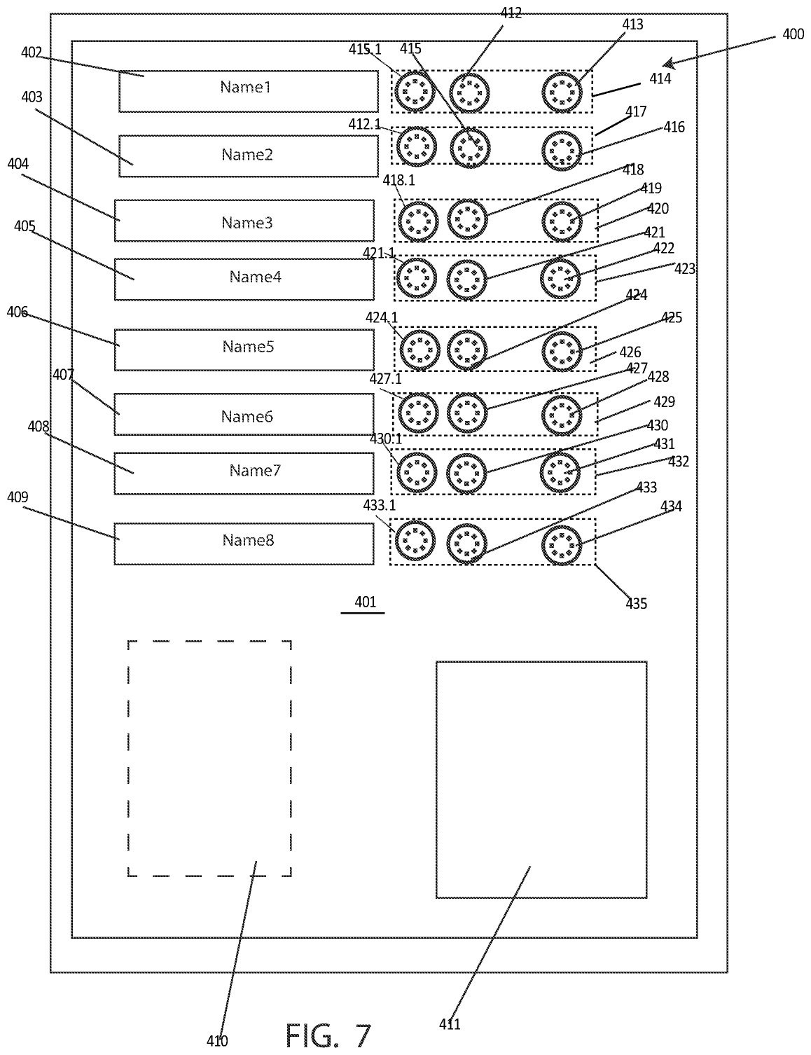

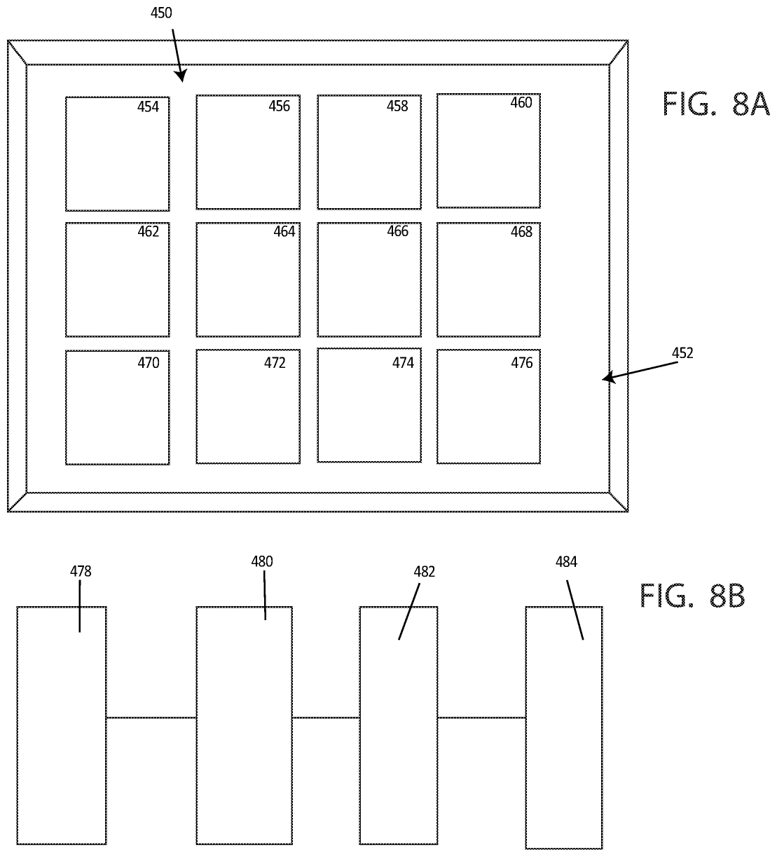

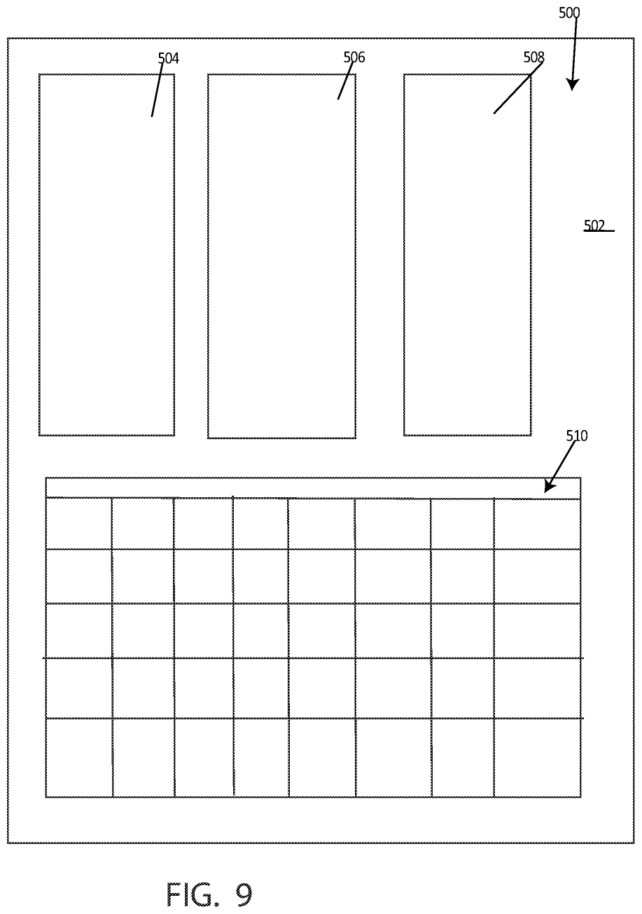

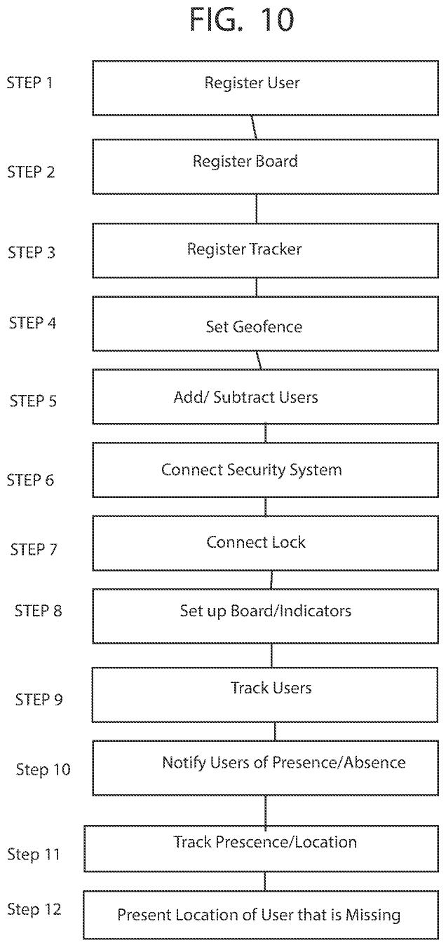

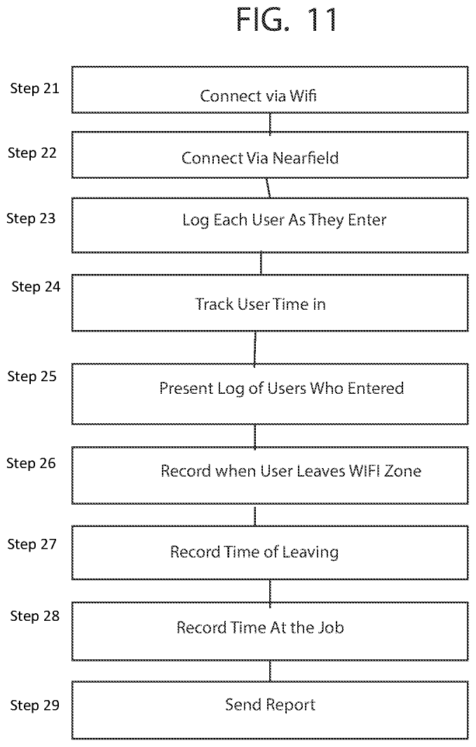

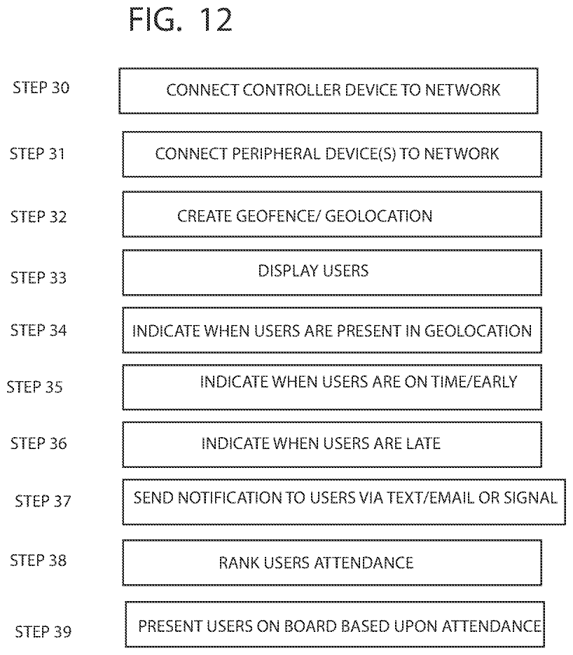

FIG. 5A is a block diagram of the server components. For example, servers 152, and 154 can include a motherboard 200, a microprocessor 202, a memory 204, a transceiver 206 where the transceiver is configured to communicate with outside components through TCP/IP or any other protocols or communication. There is also an input output or I/O connection 208, a hard drive or mass storage 210, a video card 212, and a power supply 214. Thus, with this design, a program is stored in mass storage 210, it is uploaded to memory 204 which can be a RAM (random access memory) or EE-prom which then feeds these instructions into microprocessor 202. Power supply 214 drives power to the components on motherboard 200. The information is then communicated to other servers via transceiver 206.

FIG. 5B is a block diagram of the notification systems or boards 10, 50 or 80 of FIGS. 1 and 2 and 3. These boards include a motherboard 233, which has disposed on it a microprocessor 220, a memory 222, an input output or I/O connection 224, a mass storage 226, a power supply 228, a video card 230, a transceiver 232, a video screen 234, GPS 231, wherein all of these components are coupled to a motherboard 233. In addition, coupled to this motherboard 233 are a series of lights 236, 238, 240, as well as lights 242, 244, 246, 248, 250, 252, and 254. Lights 240, and 246 can be used to determine the state of the board. While lights 236, 242, 248, 252 are for example green lights indicating the presence of a transponder. Alternatively lights 238, 244, 250, 252, and 254 are a red light indicating the lack of presence of an associated transponder. This board also includes an annunciator or speaker 237 which is configured to provide an audible beep to other parties when the person being tracked either enters or leaves a region.

FIG. 50 is a diagram of the transponder. This transponder is an active transponder which has a power supply 260, an identity chip 272 which comprises both a microprocessor and memory, as well as a transponder 274. These components are housed in the housing 258.

FIG. 6 is a schematic block diagram of a portable phone for use with the system, wherein this portable phone 300 includes a motherboard 302. Disposed on the motherboard is a microprocessor 304, a memory 306, a mass storage 308, a transceiver 310, a battery supply 312, a GPS transceiver 314, a Sim card 316, a video card 318 as well as a video screen 320. A near field detector 321 can also be present. The near field detector 321 is configured to communicate with an associated near field detector such as anyone of near field detectors 84, 86, 88, 90, or 92. There are other optional components associated with this device such as a gyroscope. With this design, instructions are housed in mass storage 308, fed into memory 306 and fed to microprocessor 304. Each of the portable phones 164, 166, 168, or 170 is configured to contain the components of the representative phone 300. An application or app can be loaded into the memory 306 of phone 300 wherein these instructions on the app can be loaded into microprocessor 304 so that microprocessor 304 can operate in coordination with microprocessor 202 or microprocessor 220 shown in FIGS. 5A or 5B to perform the functions shown in FIG. 10.

FIG. 7 is a board for use in any suitable environment, but in at least one embodiment is primarily designed for a business environment. With this view, there is shown board 400 which includes board section or base board 401, A plurality of nameplates or name regions including eight names including first name 402, second name 403, third name 404, fourth name 405, fifth name 406, sixth name 407, seventh name 408, and eighth name 409. Adjacent to each name is a display region which has three associated LEDs. The first LED is provided to indicate the presence of a person. The second LED is to indicate when the person has office hours where they are supposed to be in office. The third LED is provided to indicate the absence of that person from a particular region. For example, there is a first section 414, associated with name 402. In this first section is a first LED 412.1, and a second LED 412, as well as a third LED 413. First LED 412.1 is for example a green LED. Second LED 412 is for example a yellow LED while third LED 413 is for example a red LED (any suitable color of LED can be used). These LED's are used to indicate the presence of a person in a location 412.1, the absence of a person in a location 413 or the hours that the person is working in the location 412. For example, First LED 412.1 is configured as an LED to indicate the presence of the user in a location. Second LED 412 is configured as a yellow LED to indicate the hours that the person is supposed to be working/in office, and the third LED 413 is an LED which is configured to indicate if the person is absent.

Next, the second display region 417 is associated with a second name 403. In this section, is a first LED 415.1 which is a green LED which when lit indicates that the person is present in the location, a second LED 415 which is for example a yellow LED (for indicating whether the person should be working/on site) and a third LED 416 which when lit is for indicating that the person is out of the geographical region and which is for example a red LED.

Another region 420 is associated with name 404, wherein this section has for example a first LED 418.1 a second LED 418 and a third LED 419. These LED's are similar to the respective LED's 415.1, 415, and 416 above.

There is another region 423 which is associated with name 405 which has for example a first LED 421.1 a second LED 421 and a third LED 422. These LED's are similar to the respective LED's 415.1, 415, and 416 above.

Another region 426 which is associated with name 406 which has for example a first LED 424.1 a second LED 424 and a third LED 425. These LED's are similar to the respective LED's 415.1, 415, and 416 above.

Another section 429 which is associated with name section 407 which has for example a first LED 427.1 a second LED 427 and a third LED 428. These LED's are sir Aar to the respective LED's 415.1, 415, and 416 above.

Another indicator section 432 which is associated with name section 408 which has for example a first LED 430.1 a second LED 430 and a third LED 432. These LED's are similar to the respective LED's 415.1, 415, and 416 above.

Next, there is a section 435 which is associated with name 409 which has for example a first LED 433.1 a second LED 433 and a third LED 435. These LED's are similar to the respective LED's 415.1, 415, and 416 above.

This board section 401 also includes a near field transceiver 410 as well as a display 411, Near field transceiver 410 is configured to communicate with near field transceivers such as Bluetooth transceivers or any other near field transceivers associated with the portable electronic device such as a telephone or smart phone. Display 411 is configured as an LED or LCD display which is configured to display information regarding the great attendance, the poor presence or absence of employees or any other further information. There are also lights to indicate when the worker or employee should arrive. Thus, these lights light up when the worker is to start at 9 AM. These lights include lights 412, 415, 418, 421, 424, 427, 430, and 433. These lights light up when the start time was to occur.

FIG. 8A is a view of another board 450. This board has a plurality of different display sections 454, 456, 458, 460, 462, 464, 466, 468, 470, 472, 474, and 476. These display regions exist on background 452. Each of these displays is configured to display an individual who is present in the region as indicated by display or board 400 in FIG. 7. This board 450 therefore forms a display board which can be configured to display professionals in the building. For example, this type of display is configured to display a series of professionals for consulting, or a series of salespeople who are present in a building or area and who are configured to speak with visitors. In another use, the display board could be a series of personal trainers that the users could hire in a gym for use with training. This type of board can include a board with a LED or LCD or electronic display backing with the different sections 454-476 being arrangeable around the board section. Alternatively, this board 450 could be formed as a non electronic board wherein each section 454-476 are in the form of pictures that can be arranged around the board manually, with each region having a hollow glass enclosure allowing the different pictures to be slid therein or removed. In another alternative embodiment, the board 450 can include a non electronic backing 452, but with individual electronic screens wherein each of these electronic screens 454, 456, 458, 460, 462, 464, 466, 468, 470, 472, 474, and 476 have their own separate location for which to present the identity of an employee or user of the system.

FIG. 8B shows a series of boards 478, 480, 482, and 484 coupled together and in communication with each other. Each of these boards is similar to board 400, wherein if a location was very large with many employees such as, for example 32 or more employees, then this set of four boards which are each associated with eight names could be used to individually track all 32 employees in a job site. Since each of these boards would communicate with each other, this information could then be relayed to an application server 152 through the internet 150 shown in FIG. 4.

FIG. 9 is a view of a monitoring screen for an employer to monitor his/her employees. For example, there is a screen 500 having a screen background 502. There are sections 504, 506, and 508. Section 504 is configured to show the entrance time. Section 506 shows the names of the parties, and section 508 shows the associated leaving times, Each of these sections 504, 506 and 508 can show multiple names and can be scrolled through to show even more names. In these three display areas, the employer would be able to see when each employee arrived and when they left for the day.

In addition, screen section 502 also shows a calendar section 510. Calendar section 510 can show the days of the month so that the employer can select a particular day to see the times that the employees came into the office and left the office as shown in display sections 504, 506, and 508. With this view an employer can then monitor the attendance of their employees

FIG. 10 is a flow chart of the process for use with the system, With this design, the process starts in step 1 where a user registers with the system. In this case, the system is shown by way of example in FIG. 4. The process generally operates using microprocessor 202 in application server 152. In this case, first the user registers himself via his personal telephone with the components of the personal telephone shown by way example in FIG. 6. Next, the user registers a board such as anyone of boards 10, 50, or 80. Next, in step 3, the user optionally registers a tracker. These types of trackers can be any one of tracker or transponder) 56, 158, and 172. Next, in step 4 the user sets their geo-fence. A geo-fence can be any suitable geo-spatial area such as an electronic map which then translates this region via GPS coordinates. These coordinates are then stored in the database such as a database server 154. Next, in step 5 the user can add or subtract users via webpage. Next, in step 6 the user can coordinate and connect these communications with the existing security system. Next, in step 7 the user can optionally connect this system with a lock such as electronic lock. This process can also selectively include locking the lock automatically when the system detects that all of the users or at least a pre-defined select group of users are within the pre-defined geospatial region. Next, in step 8 the user can set up their board and indicators to indicate when a user has arrived home. The setting up of the board can include adding names and/or identities to the board as well as functionality to the lights on the board. Once this board is set up in step 8, in step 9 the system can track the users. Next in step 10, the system can notify the users of the presence or absence.

FIG. 11 shows the flow chart for tracking parties associated with a business. This process can use microprocessor 202 in any one of servers 152 and 154 or microprocessor 220 in board 221 or microprocessor 304 in portable device 300. For example, the system uses the process of FIG. 10 to register users, including steps 1, 2, 3, 4, 5, 8, 9, 10, 11, and 12. However, these steps in FIG. 11 are also being presented, as steps that are particular for a business environment. For example, the process starts in step 21 wherein the user connects via WIFI. Next, in step 22 the user connects via nearfield connection (see nearfield transponder/transceiver 410. Next, in step 23, the system logs each user as they enter a geofenced area such as a building. Next, in step 24, the system tracks the time that the user entered the geofenced area (see FIG. 9, display area 504). Next, the system presents the business owner with a log of the users who entered, (again see display area 504). Next, in step 26 the system records when the user leaves the WIFI zone. Next, in step 27 the system records the time of leaving in area 506 of the board. Next, in step 28 the system records the total time on the job for each employee, and then sends a report to the business owner see overall screen 500 which shows the report of each individual employee entering the geofenced area and when they leave and logs each of these times per day and presents a calendar 510 on screen 502 for display to a manager or business owner. This display or screen 500 can be displayed on a remote computer, smartphone, tablet or any other suitable display device. The information fed to this screen is from application server 152, and database server 154.

FIG. 12 is a flow chart for the process for use with a phone device, wherein FIG. 13 is a schematic diagram of the screen for use with a phone. For example, the process starts with step 30 wherein the peripheral device in the form of a phone such as any one of phone 164, 166, 168, or 170 connects to a server such as application server 152. The controller device is simply one of the phones or portable electronic devices or even a desktop computer. Next, in step 31, other peripheral devices such as any one of devices 164, 166, 168, or 170 connects to the network as well. Next, in step 32 the user creates a geofence or geolocation. This geofence or geolocation can be in the form of a region defined by a Wi-Fi connection or based upon GPS coordinates, with a radius formed from a central location of GPS coordinates. Next, in step 33 the system displays the users (see FIG. 13). Next, in step 34 the system displays when the users are present in the geolocation. For example, as shown in FIG. 13 there is a circle 609 or 619 indicates that the user is on a geo location. Next, in step 35 the system can indicate when the users are on time or early be indicating the time of entry via entry 602 or entry 612. Next, in step 36 the system can indicate when the users are late such as with entry 602 or 612 (See FIG. 13). In addition, entries 604, 614 are for indicating the time period the user is supposed to be present and entry 606 and 616 are for when the user leaves the location. In addition, adjacent each of these entries are pictures 610 and 620 for each of the users to be tracked. Indicators 607 and 617 are for indicating when the user is out of the geolocation, indicators 608 and 618 are for indicating a time period when the user is supposed to be in the geolocation and indicators 609 and 619 are for when the user is actually in the geolocation. Other entries 621, 622, and 623 are also aligned similarly as entries 601 and 611.

Next, in step 36 the system can send a notification such as via a text, an email or a prompt on the device that the users are either, present (step 34), late (step 36) to the geolocation or leaving the geolocation (step 37). Next, in step 38, the system can rank the users based upon attendance, such that the order of the users is based upon the frequency of attendance and whether the users are early, or late to the attendance. Next, in step 39 the system can present the users on a board based upon attendance so that the users can identify when they arrive and how prompt they are at work. Thus FIG. 13 shows the display of the results of the tracking of these users; employees on a portable device through a computerized application or app.

In all there is a system to track family members and employees of an organization in an efficient and organized manner to track presence in a geolocation. This system allows for an organized tracking of these individuals and for even ranking these individuals as to when they arrive at work

Accordingly, while at least one embodiment of the present invention have been shown and described, it is to be understood that many changes and modifications may be made thereunto without departing from the spirit and scope of the invention as defined in the appended claims.

What is claimed is:

1. A system for tracking whether people are present in a predetermined region comprising:
at least one tracking board, the tracking board comprising:
at least one identity indicator to indicate the identity of the person being tracked; and
at least one presence indicator to indicate whether the person being tracked is present in the region; and
at least one transponder, said at least one transponder being tracked for its location.

2. The system as in claim 1, wherein the tracking board further comprises at least one mirror.

3. The system as in claim 1, wherein said tracking board further comprises at least one microprocessor.

4. The system as in claim 1, wherein said at least one presence indicator comprises a light.

5. The system as in claim 1, wherein said at least one presence indicator comprises at least one red light to signify that the person being tracked is outside of the predetermined region and at least one green light to indicate that the person being tracked is within the region.

6. The system as in claim 1, wherein the region is a geolocation.

7. The system as in claim 1, wherein the region is defined by GPS coordinates.

8. The system as in claim 1, wherein the region is defined by a connection to a WIR signal.

9. The system as in claim 1, wherein the region is defined by a connection to a nearfield transponder.

10. The system as in claim 1, wherein the presence indicator further comprises an audible indicator.

11. The system as in claim 4, wherein the light is an LED light.

12. The system as in claim 1, wherein the tracking board has at least three columns of lights with at least one column of lights indicating a presence of a user in a geo-spatial area, a second column of lights indicating the time that they are supposed to be present in the area, and a third column indicating when they are not in the area.

13. The system as in claim 1, further comprising at least one display screen having at least one area listing the names of users, and at least one area presenting a calendar.

14. The system as in claim 13, further comprising automatically sending a signal to a lock to lock a lock when at least one user is detected inside of a geofence location.
